(19) United States
(12) Patent Application Publication
(10) Pub. No.: US 2006/0143103 A1
(43) Pub. Date: Jun. 29, 2006

(54) Method of facilitating, managing and financing environmentally focused projects

(76) Inventors: David A. Denne, Fairfax, VA (US); Kenneth Lee Hurdle, North Bethesda, MD (US); Gary Morgan, Oakhill, VA (US)

Correspondence Address: DAVIDSON BERQUIST JACKSON & GOWDEY LLP, 4300 WILSON BLVD., 7TH FLOOR, ARLINGTON, VA, 22203, US

(21) Appl. No.: 11/311,665

(22) Filed: Dec. 20, 2005

Related U.S. Application Data
(60) Provisional application No. 60/638,145, filed on Dec. 23, 2004.
(60) Provisional application No. 60/748,190, filed on Dec. 8, 2005.

(51) Int. Cl. G06Q 40/00

(52) U.S. Cl. 705/35

(57) ABSTRACT

A method of funding environmentally-driven public or private works projects (e.g., stormwater management and diesel fuel usage and emissions reduction projects, and generally any environmentally-driven project) that creates legacy utility or user fee-based programs so as to address urgent or mandated, environmental-related public concerns. The fund is employed to allow for projects to pass from concept to feasibility to operations stages without the need for interruption due to financial resources. Projects include any local government, State or County-influenced government, or private industry-focused initiative that triggers negative public attention and/or any potential federal sanction, penalty, or specific public notice or cost due to inaction, lack of study, or lack of seed funding mechanism. Examples include stormwater management, NPDES, floodplain management, water supply development, coastal shore protection development, wetlands banking, natural resources protection area, parks protection, water/wastewater systems, industrial air pollution abatement, diesel fuel use and emissions reductions, or other environmental development concerns.

### CROSS-REFERENCE TO RELATED APPLICATIONS

This application claims the benefit under 35 U.S.C. § 119(e) to U.S. Provisional Application Ser. No. 60/638,145 filed Dec. 23, 2004 and U.S. Provisional Application Ser. No. 60/748,190 filed Dec. 8, 2005 as Attorney Docket No. 2658-0003. The entire contents of both of these applications are herein incorporated by reference.

### BACKGROUND OF THE INVENTION

### FIELD OF THE INVENTION

The present invention is directed to (1) a method and system of facilitating and managing projects that address public, environmental-related problems by utilizing environmental-related project financing, and, in at least one embodiment, (2) a method and system for facilitating and managing, by utilizing environmental-related project financing, projects relating to water, air, land, and infrastructure, as well as industries-related pollution reduction.

### DISCUSSION OF THE BACKGROUND

Pollution and/or damage from runoff of stormwater, and the resulting negative impact on water quality, is a major problem in the United States and abroad, especially for the local governments in the US charged with oversight in this area. Contributing factors to the problem are increased urbanization, use of fertilizers and other chemicals for a variety of purposes, lack of adequate treatment facilities, and perhaps most of all, lack of adequate and enforced stormwater management programs in most communities.

Storm water discharges are generated by precipitation and runoff from land, pavements, building rooftops and other surfaces. Storm water runoff accumulates pollutants such as oil and grease, chemicals, nutrients, metals, and bacteria as it travels across land. Heavy precipitation or snowmelt can also cause sewer overflows which, in turn, may lead to contamination of water sources with untreated human and industrial waste, toxic materials, and other debris. The US Environmental Protection Agency (EPA) is charged with national oversight in stormwater and sewer overflow discharges through its National Pollutant Discharge Elimination System programs (NPDES). NPDES provides guidance to municipalities and state and federal permitting authorities on how to meet stormwater pollution control goals as flexibly and cost-effectively as possible.

Many small, medium and large communities across the United States currently are struggling to comply with the latest round of the Environmental Protection Agency's (EPA's) National Pollutant Discharge Elimination System (NPDES) regulatory requirements and standards. These regulatory requirements, enacted in 1990, demand that communities take a series of actions called Best Management Practices or BMPs to measure, track and control pollutants found in stormwater discharges in their defined political jurisdictions, or face very stiff financial penalties for their noncompliance. Many large cities and counties over 100,000 were required to comply with Phase I of the NPDES regulations in the early 1990's, and are now challenged with their second 5-year permit, requiring more costly and stringent control strategies. Phase II of the NPDES regulations implemented in the late 1990's require all “urbanized areas” in the US (as defined in the latest census) to comply with the NPDES standards. These changes now require small, medium and large sized communities to comply with the regulations.

Becoming compliant requires expenditure of funds for:
Studying the stormwater management system in the affected communities;
Determining steps necessary to correct NPDES-noncompliant and polluted stormwater;
Determining steps that could effectively channel and treat polluted stormwater for treatment and recharge of water supplies;
Establishing stormwater management programs for long-term correction and control of stormwater systems; and
Establishing and maintaining adequate funding for maintenance and continual upgrade of the established stormwater management program in affected communities.

Recently, according to EPA records, nearly 7,000 counties and municipalities were required to comply. Actions that could be taken by EPA could bankrupt the local communities if the legislated and programmed fines were imposed and enforced—a prospect that is now looming ominously in thousands of areas. In some communities, lawsuits have emerged over the issue, further complicating a problem that threatens economic stability of some of the jurisdictions. Meanwhile, aging stormwater infrastructure and inadequate stormwater policies and programs continue to add to existing problems. EPA's cycle now in place involves active compliance assessment, with potential penalties to local governments that are ignoring the problem. These are, of course, the same local governments who are financially unable to marshal the resources to deal with the problem on their own. Additional pressures come from EPA's strategy to delegate authority for program oversight and regulation to State governments, many of whom face huge deficits, resulting in under-funded compliance programs. When serious problems emerge, though, even in under-funded States, the threat of federal penalties and sanctions force governments to take action and find resolution to stormwater problems.

Efforts to address some of these problems have been previously made. For example, there is adequate engineering talent available to the vast majority of affected communities needing studies, and technologies and systems to manage and treat polluted stormwater are known, tested, and proven effective. Moreover, some technical understanding of stormwater management systems and policies also exists in most communities, and political and governance understanding of the basic issues are in place in nearly every affected community.

Nonetheless, there are very high and stressful financial pressures on local, municipal and county governments to design, build, operate and maintain buildings, facilities and public infrastructure of all kinds. As a result, sometimes even modest investments in stormwater-related facilities and programs are too great to be included in the local government funding cycle. This too often means that the hidden, non-point source pollution, erosion, and water quality problems go unnoticed while they continue to worsen.

Lack of citizen awareness contributes greatly to the problem. While community residents live in subdivisions that were built under local design standards for drainage, and while they shop and work in centers that likewise were constructed under certain mandated conditions, these same citizens do not regularly witness the impact of inadequate stormwater management. Condition and maintenance care of storm drains, water diversion and collection facilities, stormwater management ponds, creek and stream beds, and the like regularly are left to chance, except when disaster strikes. Major flooding events, dam breaks, and major sewer backup problems affecting communities cause the regular, everyday problem of inadequate stormwater management to receive immediate, high-level attention, right at the very time that its damage has been done.

Despite EPA enforcement efforts increasing several fold, communities across the US are still struggling with methods for both dealing with the growing local stormwater problem and dealing with methodologies for funding of the solutions. Some, forced by disastrous flooding, have to reallocate municipal funding to correct serious problems. This is typically a short-term solution to an immediate problem, not the creation of a program to resolve the overall community stormwater challenge. Others, realizing that stormwater management programs and infrastructure represent a “ticking time bomb” for the local government and affected communities, pass difficult budget tests to provide funding for stormwater programs. Others employ the use of special districts assessments, development fees, bond financing, grants, or tie-ins/ride-on measures for parking, transportation or other assessments, taxes, or fees to finance stormwater solutions. More forward-looking communities are beginning to put a new structure—enterprise funding or a stormwater management utility—in place to help manage and resolve this difficulty. Since the mid-1970's when this funding strategy structure first appeared, more than 400 such utilities have been created.

These stormwater management utilities represent the “new” methodology for tackling aging stormwater management policies and built infrastructure. By both EPA and private environmental study group estimates, the need for stormwater utilities exceeds 9,000 and the number of expected stormwater management utilities to be created in the next decade exceeds 2,500. The utilities operate like other publicly-owned enterprise activities such as water, sewer and solid waste utilities. In fact, the new stormwater utility often may “ride on” these other utility's billing and administrative processes that are already in place and functional, thus simplifying the process.

The basic concept of the utility is that users are charged fees for their usage pattern versus the costs of these services allocated on the basis of property value through the general revenue fund of the municipality or county. Done the right way, careful engineering investigations and processes are undertaken to determine and measure impervious areas that channel or divert stormwater, and these calculations form the basis for the meticulously designed user fee calculations that serve as the basis for a community's stormwater rate billings structure. The full concept in operation produces revenue which is used to both administer the program and fund stormwater management-related improvements, corrections, and upgrades across the affected community.

The process works in those communities that can afford the upfront fees associated with all of the necessary engineering studies and user fee calculations. Unfortunately, most US local governments simply do not have the available revenues to undertake this kind of investment, regardless of the potential returns that can be gained. Therefore, stormwater management-related problems continue to be a source of major frustration, as well as a potential financial liability, for these affected local governments.

A different, but related, environmentally sensitive issue is the emissions from engines using various types of petroleum products that have been recognized as primary sources of air pollution worldwide—especially in congested urban centers in major cities and suburban areas around the world. Diesel fuel, in particular, is responsible as a major polluting substance and unfortunately is a primary fuel type for the distribution, construction, manufacturing, farming, and transportation-related industries both around the globe and in the US. Work on the part of the EPA, car manufacturers, and component manufacturers has resulted in dramatic improvements in both efficiency and reduced pollution effects of newer engines, both diesel-fueled and otherwise, over the past three decades. In fact, using diesel as an example, stringent diesel fuel emissions standards went into effect for new on-road engines in 2004, and even lower standards go into effect in 2007. Stringent standards for off-road equipment take effect in 2008. Additionally, EPA has succeeded in getting in place a national use requirement for ultra-low sulfur diesel for 2006 for on-road equipment and for 2010 for off-road equipment. These and other significant legislative, rulemaking, and regulatory changes have had a positive impact on lower emissions from newer engines in use around the US and the globe. It is expected that the effort to continue working with industry on standards for new engines will reduce fuel usage overall by creating more efficient machines, the end result of which also reduces emissions from the engines and machinery.

Improving engine efficiency and reducing emissions from older engines represent a dramatically more complex challenge. EPA estimates that there are more than 11 million existing, older diesel engines in use in the US alone. Tackling the chore of reducing fuel usage and emissions for these older engines involves a mixture of employing engine efficiency technologies, emissions reduction technologies, and incentives and/or penalties to motivate users to consider retrofit solutions. EPA, industry associations, State and local governments, and even users themselves have had success in employing the technologies, most of which have proven to be very effective. This success, though positive, has been limited primarily due to the lack of owner capital to afford more widespread employment of the many available technologies.

Complicating the problem is the fact that diesel engines are highly reliable machines, run and function generally trouble-free for years, and are relatively simple to repair when problems arise. Therefore, the older diesel engines are unlikely to be “replaced” due to workability or reliability issues in any reasonable short-term period of time, so the only logical method of affecting fuel and emissions reduction is through effectively managed retrofit initiatives, for which traditional funding sources have been limited.

EPA has formally adopted a goal of retrofitting all 11⁺ million, older diesel engines now in use. EPA, State governments, local governments, and industry groups alike have spent millions on various grant programs, retrofit demonstrations, technology showcases, and area-wide, industry-wide or company-wide retrofit programs. While all have had positive impact on improving air quality by reducing emissions, and many have likewise proven cost beneficial for owners in reducing fuel usage, the programs nonetheless have barely touched any progress in the global or US problem resolution. Simply meeting EPA's stated goal of retrofitting the 11⁺ million, older diesel engines in the US would take multi-billions of dollars.

Various forms of financial incentives and mandatory retrofit initiatives have helped make progress toward the reductions goals, but these efforts are generally plagued difficulties and unfortunately limited in their accomplishments. EPA's grant programs with industries and non-profits continues to be a positive source for retrofit programs, especially since the agency tends to favor those initiatives that allow for maximum use of EPA dollars in the purchase and employment of the proven technologies and equipment. Despite these efforts, though, a patchwork of small, mostly limited geography and group-based solutions is the result of current funding initiatives in the diesel market. There exists, therefore, a crying need to deliver innovative funding from non-traditional government sources in order to spur further progress in this area.

Industry groups and users are not at odds for the most part with EPA efforts to reduce diesel emissions and, of course, are highly in favor of any initiative that reduces fuel usage, since that equates to lower costs and therefore higher profitability. These same groups, however, are always lobbying EPA and their industry groups for greater and wider-ranging financial assistance and incentive programs, for which there is never enough budget to go around. Again, the end result is frustration resulting from the availability of technologies that could improve efficiency and reduce emissions, but the inability to afford the “medicine” for repair.

Undertaking and contracting for involvement in diesel fuel usage and emissions reductions initiatives are actions that are appealing to a majority of diesel engine owners, especially those employed by or associated with corporate entities. EPA involvement in this area has not been associated with imposition of fines, except in very rare cases involving major manufacturing abuses that have resulted in area-wide health difficulties. The degree of industry acceptance and willing requests for assistance (particularly in the funding of programs) from EPA has been noteworthy. One representative example of this industry-wide willingness to participate in programs of this type exists in the trucking industry of the US, a major user of diesel fuel.

The trucking industry transports the largest share of any freight transportation mode, accounting for nearly two-thirds of the freight tonnage transported in the US in 2002. The trucking industry is also a major contributor of air emissions from the freight sector and accounted for two-thirds of the NOx and PM emissions from freight transportation in the U.S. in 2002. Demand for transport by truck and rail has dramatically increased over the past 20 years, to the extent that travel currently exceeds the infrastructure capacity to handle it. EPA has established strict emission regulations for diesel engines used in the trucking industry, which are expected to decrease air emissions.

The SmartWay Transport Partnership is a voluntary EPA program that provides trucking companies (including owner-operators) with market-based incentives to reduce emissions. The program is designed to reach all stakeholders related to the industry. Shippers commit to decrease their environmental impact, and to increase the use of SmartWay carriers. Carriers commit to adopt technologies and strategies that improve fuel efficiency, thereby both saving money and reducing their emissions. As a result, carriers are encouraged to continue to improve their environmental performance so that their company is more attractive to potential shippers that may hire them. This provides trucking companies with a direct incentive to reduce overall fuel expenditures, increases vehicle efficiencies and, at the same time, reduces their emissions overall. These actions, in turn, contribute to stabilization of consumer prices for products shipped. Finally, of course, the reduction of adverse environmental impact serves the citizens' best interests overall. All SmartWay Partners receive recognition for their efforts through press releases, publications, the SmartWay website, etc. The Partnership therefore represents a win-win-win for participants, the public, and the environment.

Through its SmartWay Program, EPA has worked with trucking companies and other industry representatives, manufacturers, laboratories, and other groups to identify, test, develop, and offer innovative strategies that provide the opportunity for reducing fuel consumption and emissions of vehicle fleets and individual vehicles. For current in-use vehicles, a major market impediment is the upfront capital cost associated with vehicle owners purchasing available and proven technologies and products that can reduce their fuel use and emissions. Thus, the lack of available “seed” capital to invest in logical vehicle improvements inhibits growth of SmartWay participants.

Since most retrofit emission reduction technologies generally provide little or no intrinsic economic benefit to the user, there is little incentive for vehicle owners (particularly small private companies and owner-operators) to acquire and use these products. However, if a program or incentive were developed that provided direct economic benefit without the need for use of upfront cash to acquire the products, then companies and organizations would gain an accountable advantage for their interest in emission reduction technologies. Such a program could bundle innovative fuel saving technologies along with traditional retrofit technologies to create savings in fuel cost that would, in turn, pay for additional emission controls. Most small to medium sized trucking companies do not have the capital to invest in these technology bundles.

Historically, traditional methods of solving environmental issues have been funded through a variety of sources including Federal and state grants, loans, tax incentives, credit and trading programs, and Supplemental Environmental Projects (SEPs) resulting from violation settlements, to name a few. Although these funding mechanisms are effective in helping to mitigate environmental issues in the short term, they do not provide a recurring funding stream on an ongoing basis needed to permanently solve the problem in the future. As pointed out above, the environment and the EPA are in need of an innovative mechanism that can leverage public funding with private capital on a continuing basis to permanently address the growth of expanding environmental challenges and solve a wide range of current environmental problems.

Undertaking and contracting for engineering studies that reduce stormwater, diesel engine, and other specific environmental media pollution impacts, as well as establishment of user fees and/or utility establishment to reduce pollution impacts, are actions that are appealing to the majority of public governmental and/or industry audiences. Among the obstacles encountered in undertaking these processes are:
1) Education curve of both the government officials and industry/user audiences (having them up-to-speed on the EPA process, potential and/or impending penalties and sanctions, strategies to correct pollution effects, and the types of projects that could be executed to make a difference);
2) Legal, administrative, and regulatory barriers at the State, local, or corporate levels that may limit creative solutions to the problems;
3) Political leadership in the local governments and corporate leadership with the industries willing to tackle controversial problems in their jurisdictions and markets;
4) Political, governmental officials', and corporate leaders' understanding of the process for and reasonable costs of undertaking creative solutions, and of course,
5) Funding to undertake the work.

Items 1-4 above can be logically and iteratively worked out in any jurisdiction or industry/company threatened by the prospect of fines, penalties, sanctions or exorbitant costs, and there are literally thousands of such prospects. Item 5—MONEY—is the remaining and key obstacle for this market opportunity. Even with answers and support from all of the parties on Items 1-4, the lack of funds to allocate to problem resolution has killed and threatens to kill thousands of very worthwhile projects.

### SUMMARY OF THE INVENTION

The method of facilitating and managing projects involves using innovative engineering management, technologies, and financing improvements that have not been employed together in a system to address public environmental issues. (Because of the variety of environmental media to which the methods and systems apply, some logical variation in methodology steps may occur from project-to-project.) This method (and its corresponding system such as a computer system) is performed under the control or in conjunction with a Concept and Managing Entity (hereinafter referred to as the “Concept Entity”). This Concept Entity employs technical, management, financial, and engineering resources of its own as well as contracted resources of numerous outside specialized experts by media type (water, air, land, Industries and Infrastructure-pollution related experts). In addition, the Concept Entity manages projects in separate organizations dependent on the environmental media involved (Water, Air, Land, Industries, and Infrastructure).

The techniques discussed herein can be applied to a variety of environmental-based problems. The techniques may address reduction, control or management of pollution, emissions, or effluent, or change the circumstances in the media that affect environmental health and welfare in regards to that media. The techniques can further be used to address public environmental concerns or hazards that are monitored, tracked, observed, and in some cases, regulated by public bodies. Many of the techniques can be applied to situations or environments where there exists some level of attention and oversight by public/governmental entities, even though the funding for resolution of the problems is inadequate to effect overall problem elimination.

Applications of the present invention may also achieve at least one of the following positive factors:
Some form of repayment of the invested capital;
A return-on-investment of invested capital;
A financial return for the Concept and Managing Entity; and
A partial re-charging of the revolving environmental fund to enhance the Fund as a socially-conscious investment opportunity.

The invention involves at least one or a combination of: user fees, shared savings, utility establishment, income or proceeds splitting or sharing, or progress payments of some form based on either documented environmental change or financial-related and investment parameters of the environmental solution proposed by type of media (water, air, etc.).

Preferably, a revolving project fund dedicated for use on local government, municipal, State, Federal, or private environmental projects is employed that may be media-specific or that may be a revolving environmental-related project investment for multiple media. This process also allows for direct or indirect involvement of governmental entities through grants, contract procurement, or voluntary/contributory methodologies. To facilitate this aspect of the process, the process is employed and managed by a Concept Entity that is comprised of a series of operational companies by media (air, water, land, etc.) and by two distinct funding companies that administer its fund (e.g., either one or both of a project-specific fund or a fund (e.g., a revolving fund) that can be reused for other projects after at least partial repayment). One of these funding companies is a for-profit entity designed to handle and administer privately invested funds, while the other is a non-profit entity devoted to serve the interests of a number of foundations, private investors, and governmental authorities who may wish to further environmental goals and surge positive environmental change through this invention with contributions, grants, or service-in-kind. Employment of nonprofit contributions or government-sponsored grant monies as contributing dollars to the inventor's fund can be used in the present invention. The mission of resolving environmental problems is one in which a number of not-for-profit, socially-conscious for-profit, and government agencies alike may choose to support through voluntary or competed programs (e.g., grants).

A concept entity's revolving fund may have one or more has a number of defining and distinguishing features. For example, a revolving fund may be:

dedicated to applied resolution of environmental problems in a wide variety of media;

organized to accept both public/non-profit as well as privately invested resources; and/or

administered and managed to achieve project undertakings and create returns that benefit clients, participating investors, the Fund itself, and stakeholders in the environmental projects that are undertaken.

In one embodiment, the Fund is not dedicated solely to one particular project type or any particular project within that type, so it is for this reason not designed to serve simply as a privatization or public-private partnership-dependent mechanism. Such projects alternatively involve a group of investors who band together to execute a project that brought them together solely for that particular project (i.e., to build a road, a building, a plant, etc.). Thus, project-nonspecific, revolving funds are driven by at least one environmental need, and they execute projects that are triggered by and are undertaken primarily because of an environmental or environmental health and welfare-related concern. Second, the projects undertaken by project-nonspecific, revolving funds always involve a component or measure that generates a return to the Fund itself for the purpose of advancing further environmental project undertakings (hence its “revolving nature”). Alternatively, revolving funds that are media-specific or project-type-specific can be used also and made revolving such that the projects undertaken involve a component or measure that generates a return to the Fund itself for the purpose of advancing further environmental project undertakings. Such funds are known as media-specific revolving funds and project-type-specific revolving funds, respectively, but are always driven by at least one environmental need, and they execute projects that are triggered by and are undertaken primarily because of an environmental or environmental health and welfare-related concern.

Key projects of concern are those that offer the potential for longer-term user fee, shared savings, or utility establishment to solve urgent or mandated, environmental-related public concerns. The fund is employed to allow for projects to pass from concept to feasibility to operations stages without interruption due to financial resources. Ideal projects include any local government, State or County-influenced government, or private industry-focused initiative that triggers negative public attention and/or any potential federal sanction, penalty, or specific public notice or cost due to inaction, lack of study, or lack of seed funding mechanism. Examples include stormwater management, NPDES, floodplain management, water supply development, coastal shore protection development, levee construction and/or maintenance, wetlands banking, natural resources protection area, parks protection, water/wastewater systems, industrial air pollution abatement, diesel fuel use and emissions reductions, or other environmental development concerns.

Investors of the fund managed by the Concept Entity are repaid through at least a portion of the user fees or utility fees collected from the public works or environmental projects. Two example projects are outlined in detail, where the first is water-related (e.g., stormwater management) and air the second is pollution-related (e.g., diesel fuel usage and emissions reduction). Additional examples of land, infrastructure, and industries-related pollution are summarized herein as well.

In one embodiment, a fund is used for financing environmental projects, operates on a project basis, and includes the provisions necessary for competing for attention and contract awards with other methodologies for executing these environmental problem solutions. In such an embodiment, more that just capital for problem resolution is addressed. In such an embodiment, it may not be just a loan, grant, or borrowing instrument of any kind such as would be offered through a bank, credit union, or other financial institution. Rather, the teachings herein can provide a combination of: a logical problem resolution process, an execution team and process, and a fund for capital resources to expedite the solution.

According to one exemplary method of the present invention, local governments obtain privately-generated investment monies aggregated in a fund as a source of capital for undertaking public works and environmental projects (e.g., stormwater studies and utility creation studies), rather than utilizing difficult-to-obtain governmental funding. The method and process enable a municipality or county government to begin the process of undertaking a public works project in a shared risk/shared reward process for communities who may consider establishment of stormwater utilities.

Also according to a second exemplary method of the present invention, trucking companies obtain privately-generated investment monies aggregated in a fund as a source of capital for undertaking environmental projects (e.g., diesel fuel usage and emissions reductions projects), rather than utilizing scant governmental, industry, or corporate operations funding. The method and process enable the trucking companies to begin the process of retrofitting diesel fuel trucks with equipment and technologies in a shared risk/shared reward process for companies and diesel owners who may consider acceptance of user fee or shared savings financial arrangements.

According to an exemplary method of the present invention, local governments obtain privately-generated investment monies as part of accepting a process and a source of capital for undertaking public works projects (e.g., stormwater studies), rather than utilizing traditional governmental funding. The invented method enables a municipality to begin the process of addressing an improvement for an environmental issue (e.g., a stormwater issue) in a shared risk/shared reward process that uses leveraged private capital in a specially designed and managed, revolving public works and/or environmental fund available to local communities who may consider establishment of an environmental management utility (e.g., a stormwater management utility) or other type of user fee arrangement. In this case, the Concept Entity's environmental organization manages the process and projects.

### BRIEF DESCRIPTION OF THE DRAWINGS

These and other advantages will become more readily apparent and more readily appreciated from the following detailed description when taken in conjunction with the accompanying drawings in which:

FIGS. 1A and 1B form a flowchart showing traditional, known and typical processes for handling stormwater management SWM) related study and funding issues;

FIGS. 2A and 2B form a flowchart showing an improved method for handling public works and environmental (e.g., SWM) related study and funding issues;

FIGS. 3A and 3B form a flowchart showing traditional, known and typical processes for diesel emissions and fuel usage reduction study and funding issues; and

FIGS. 4A and 4B form a flowchart showing an improved method for handling environmental (e.g., diesel fuel usage and emissions reduction) related study and funding issues.

### DETAILED DESCRIPTION OF THE ILLUSTRATED EMBODIMENTS

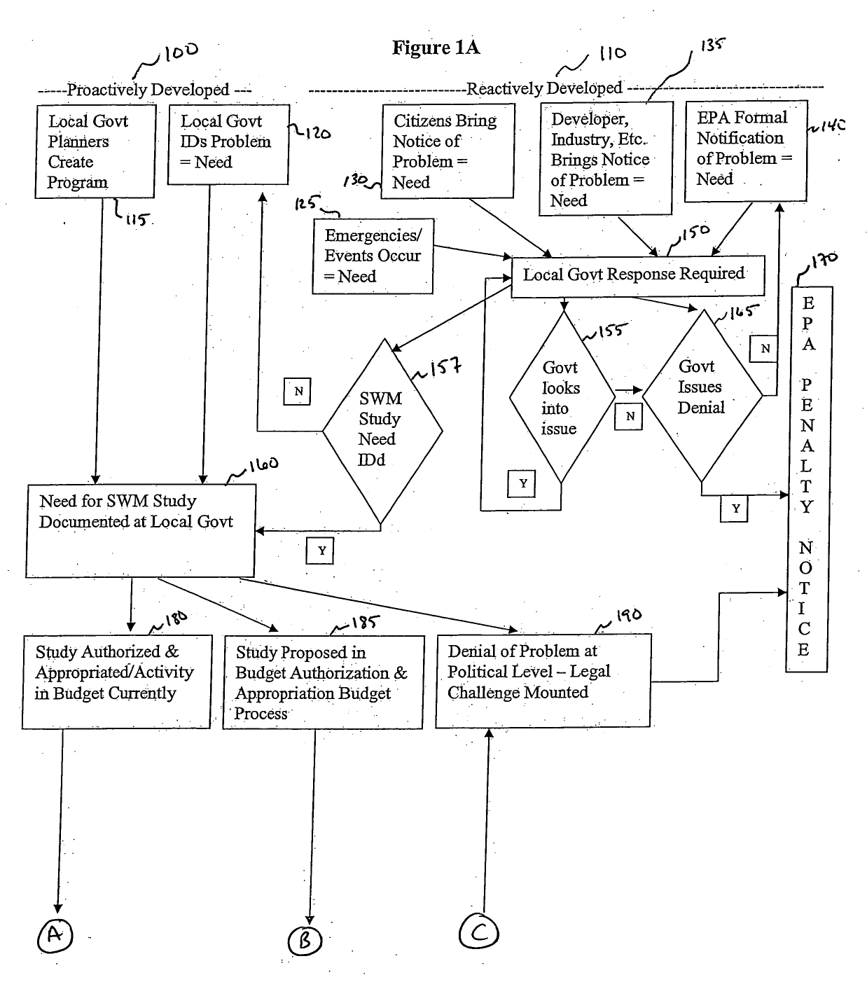

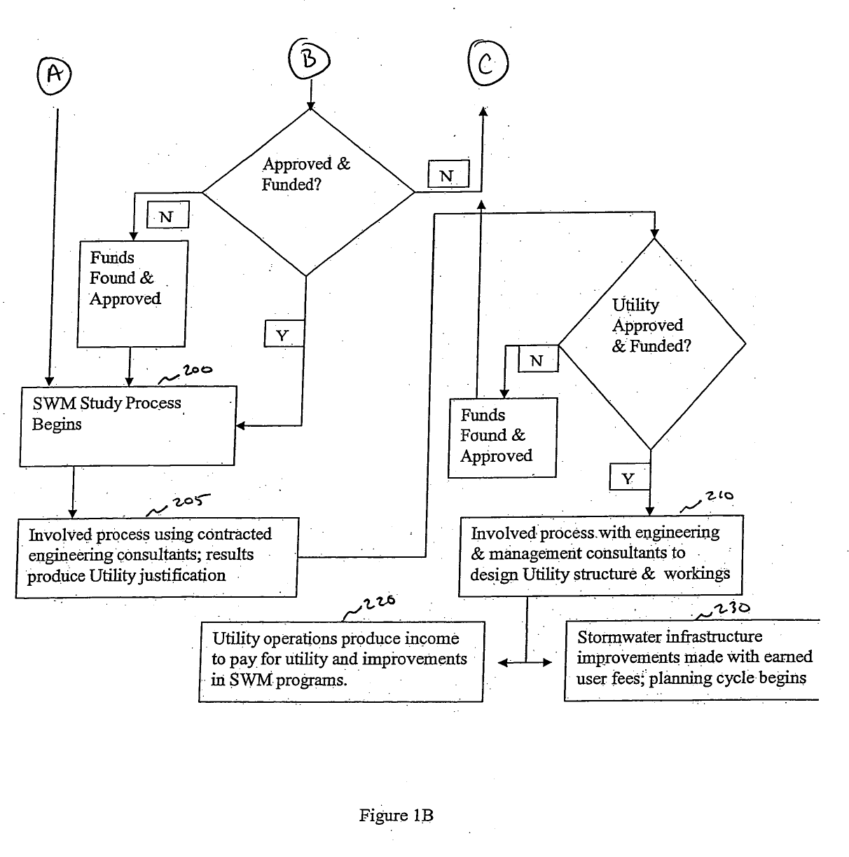

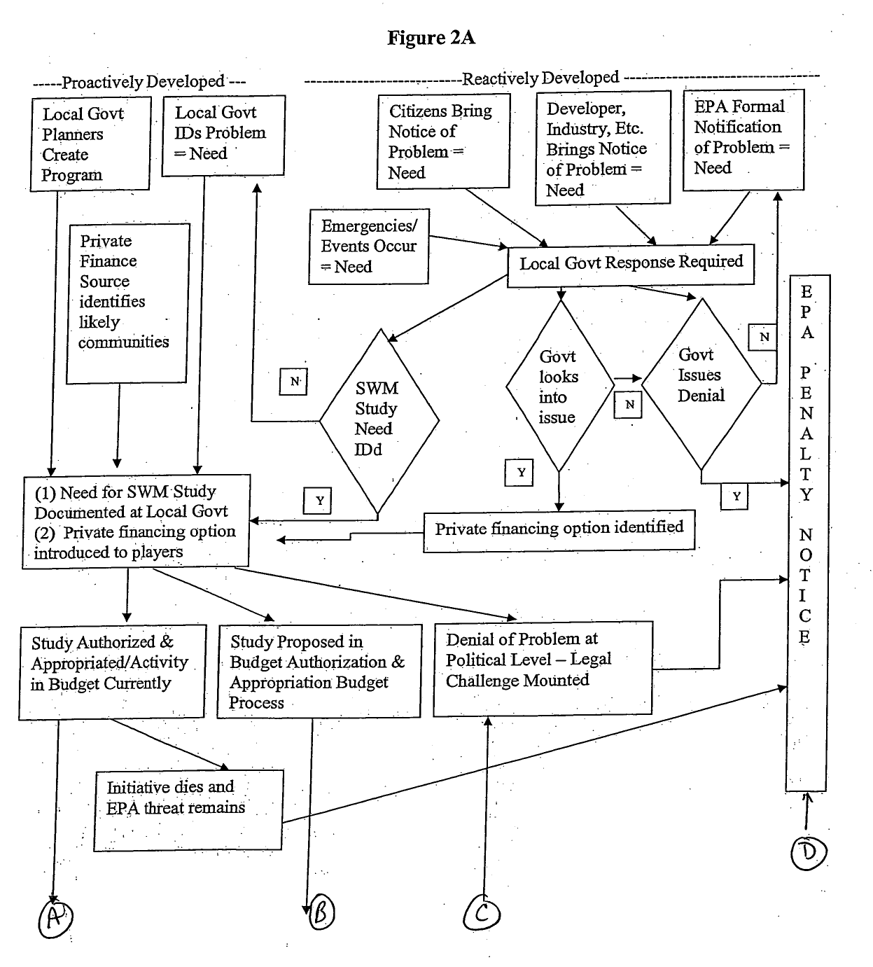

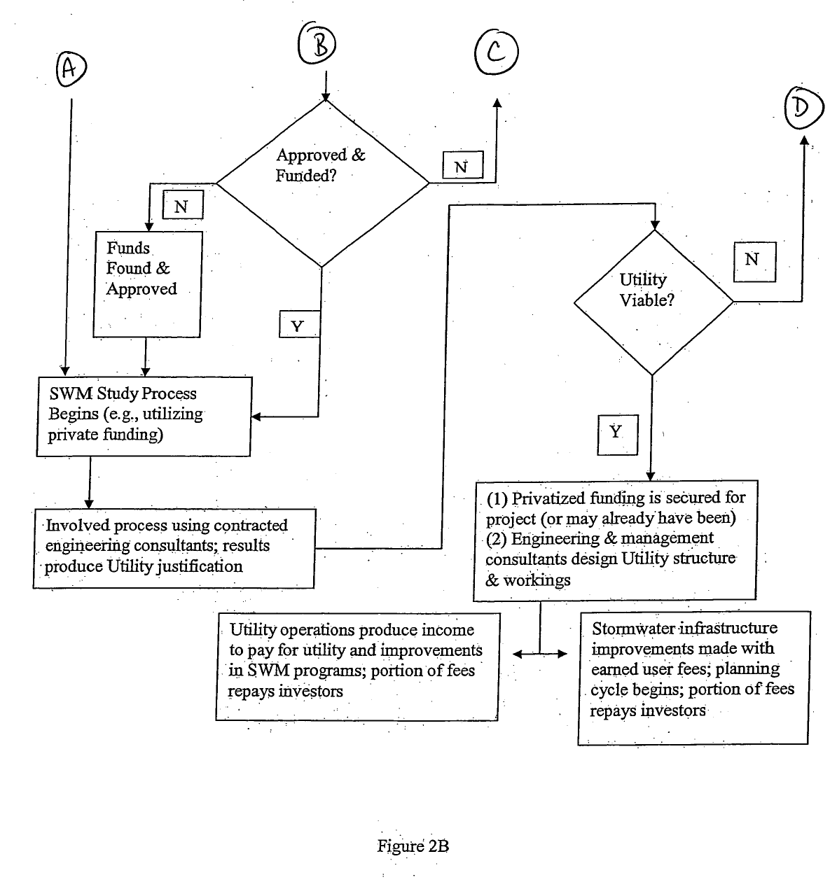

Turning now to FIGS. 1A-2B, the present invention will be described with reference to how a process and privatized funding can be integrated into the public works and environmental project processes. Turning first to FIGS. 1A and 1B, that flowchart tracks the overall process flow for stormwater management decisions at the local government level as they might relate to Local Government Approval and Development of a Stormwater Management Utility.

The general process begins with actions that represent awareness of stormwater management and/or systems problems. These actions are either proactively developed (100) or reactively developed (110). Proactive development involves a forward-thinking local government public works, planning, and/or engineering department that either creates (115) a program for monitoring and management of stormwater within its watersheds or that employs active surveillance programs (120) to allow for early identification of problem areas in the watersheds. Such proactive-focused efforts would document the extent of damage or impending damages, and form the program justification for a specific stormwater management study. These paths are the fastest path to successful establishment of a stormwater utility.

On the other hand, reactive development (110) can be triggered through a wide variety of events:
Disasters or emergencies occur that bring immediate recognition to the stormwater management problems in a local community (125);
Citizens living in fringe areas of stormwater facilities, or active citizens' groups that use and track community open space, bring notice to erosion, inadequate maintenance, or evidence of damages to open space land that is dedicated to stormwater uses (130);
Citizens likewise bring notice to contamination of wells or groundwater/water sources (130);
Developers or industrial concerns wishing to develop certain large parcels of land must deal with stormwater issues in their permitting process for projects, and often trigger stormwater investigations and programs (135); and
EPA on its own, through State conservation or other agencies, or through local concerned citizens' group involvement, gets involved in the issue through notifications of noncompliance with NPDES requirements (140).

Reactive development by its very nature entails a potentially combative process that both raises emotions over the stormwater issue and forces a greater bureaucratic response to creation of solutions. Unfortunately, as it affects stormwater management, reactive development of programs is by far the more regular path of development. Regardless of the event that prompts a reactive development, some sort of local government formal response (150) is required. Typically, unless the public works or engineering departments have active watershed inspection programs, the government response is “to look into the issue” (155), which really results in a delay in the real response to the problem. In this case, local leadership will task a department or specialist (contracted or otherwise) to produce an analysis of the problem, and then a formal local government response is issued.

Whether a “look into the issue” is triggered or officials are at the ready with information, only two other outcomes are likely:

1) A stormwater program study need is identified (157/160); or

2) The local government issues a denial of any problem (165).

A denial, of course, leaves open a path for State, EPA, or joint State/EPA examination of the difficulty. This could lead to issuance of a notification or penalty notice (170) to the jurisdiction. Identification (160) of the need for a study, on the other hand, prompts documentation of the problems and creation of parameters and process for a stormwater management study to be undertaken. At this stage, either the study is: within the budget program currently in place (180); the study must be proposed for the next round of budget preparation (185); or the question of the need enters the political arena (190) where legal and other challenges concerning the issue are raised (again potentially raising the specter of enforcement or penalty actions). Any action beyond that involving funding currently available in established budgets indicate time delays (sometimes very significant) into the process.

After budget process and time delay-related problems are tackled, the actual process of beginning a stormwater management program study is initiated. Most local governments in the US lack the internal engineering expertise to undertake a stormwater management study. As a result, services (200, 205, and 210) are procured through outside-contracted activities, typically involving an engineering consultant selected through some existing contractual arrangement or through some procurement process.

While engineering costs for this type of work certainly are affected by regional cost fluctuations, it is fair to say that the there is also cost variation due to the size of communities being studied. Small communities (<50,000-100,000 in population) vary dramatically in initial study costs versus medium sized communities (<250,000) or large communities (250,000-500,000). A logical national average cost of such a study, though, is $300-500 thousand dollars. In many jurisdictions, the study cost alone is enough to scare off even positive-minded public servants. Complicating this issue is the fact that conduct and scope of the initial engineering studies vary greatly from area to area, resulting in a wide degree of differences in reliability and complexity of results.

Unfortunately, this wide dispersion of complications and results also sometimes sidelines the creation of a stormwater utility to correct problems. Recognizing the market potential that exists as a result of these circumstances, a number of major water resources-focused engineering firms around the US have created specialized engineering centers of excellence that focus on stormwater consulting. A few have created specialized service offerings to include stormwater utility consulting. Use of such a firm greatly simplifies the work for a local government, and potentially offers cost savings in the event a stormwater utility operation is considered feasible. Nonetheless, FIGS. 1A and 1B depict the much more typical process of a procurement selection of a local engineering firm for a stormwater study, and then a separate procurement later for establishment of a stormwater utility operation, since most communities do not have existing contractual relationships with such niche firms.

The general process for local government approval and development of a stormwater management utility (FIGS. 1A and 1B) then ends with a hired consulting firm establishing and assisting in initial operation of the utility. Average costs for utility feasibility and operations set-up studies ranges from $300,000-$800,000 per utility. Of course, after the utility is up and operating, income flow from user fees results in available funds for both operation (220) of the overall utility and stormwater management program and infrastructure improvements (230) throughout the jurisdiction. According to the EPA, in communities that have already developed such utilities, the success of the programs has been both notable in terms of water quality improvements and acceptable to most of the affected communities. In fact, an established stormwater utility has never financially failed in the U.S., though attempts to establish these utilities occasionally have resulted in failure due to inadequately planned and executed study and entity creation programs.

Turning now to FIGS. 2A and 2B, the method of the present invention reduces risks on the municipality by providing funding from sources other than the municipality or the local government itself for costs associated with the corresponding public works and environmental projects. While those figures illustrate the private funding being utilized for the study and the building and/or maintenance of the public works or environmental improvements, it is possible to privately fund any one or a combination of costs without departing from the spirit of the present invention. Moreover, it is possible to fund a portion or percentage of any one or a combination of costs without departing from the spirit of the present invention such that the private investor and the municipality share in the risk/reward of the project.

Prospective target communities that would benefit from the present invention may be determined using various factors. Such factors include but are not limited to:
Existing EPA notifications of noncompliance;
Known stormwater infrastructure deficiencies;
Known stormwater management program deficiencies;
Growth ranking of the community (population);
Growth ranking of development potential in the community (developable acreage);
Flood hazard potential;
Stability of local political leadership;
Strength of local political leadership;
Strength of community planning, engineering, or public works departments;
Local government relationship with qualified engineering consultants;
Availability and interest of key niche water resources firms experienced in stormwater investigations and utility consulting;
State and/or local restrictions prohibiting privatization initiatives; and
Local track record in undertaking and completing capital infrastructure upgrade programs.

However, unlike known processes that utilize a community's standard project procurement practice, the present invention utilizes alternative project financing in order to fund various stages of the project. Doing so may require tactical meetings, briefings, and privatization concept introductions to both key political and technical leadership in the communities. The approach also involves tactical outreach meetings with known and respected “legacy” engineering contacts at the local level who understand the issues, geography, topography, water resources profile, and development-related impacts of their local community.

To implement the project, a variety of team members and experts may be utilized, including but not limited to investor representatives, fund leadership/officers, experts in stormwater management studies, utility program managers, and technical staff of contracted engineering support specific to detailed engineering tasks. A private funding option proposal is then prepared and presented to local leadership for consideration in resolving the community's stormwater management difficulties.

When preparing to implement a project, one first prepares an outlined, logical approach for completion of a stormwater management study of the entire affected community. It may be beneficial to employ outreach techniques geared to reach the affected stakeholders (businesses, citizens, political leadership, etc.) in the community so that results of the technical stormwater study, when presented, are understood and appreciated. One would then look to a local community's commitment to officially consider establishment of a stormwater utility program if dynamics uncovered in the study confirm viability of the stormwater utility approach. This step generally necessitates the local municipality's action in passing an ordinance allowing for creation of the stormwater utility. According to the present invention, project financing for both the initial stormwater study and the utility set-up and creation can be provided through environmental-related project and/or non-municipality resources. Further, depending on the conditions of the financing, it may not even be required that the initial study costs be repaid unless a stormwater utility results from the process. If a utility were to result, then financing can also include sufficient financing for the establishment and initial six-month set-up and operation of the stormwater utility, thus allowing the local community to launch a complete stormwater management program without budget expenditure of funds they do not have and cannot easily get through other means.

To aid municipalities facing difficult financial crises at the same time they face critical stormwater environmental problems, the present invention also includes a methodology allowing a community a “test” methodology for examining the feasibility of a utility approach. Recognizing that the initial study costs are often prohibitive factors for a municipality decision to consider stormwater management and utility solutions, the inventors have fashioned a rapid assessment study methodology for use in its process to aid municipalities. This methodology embodies a committee-like collection of basic geographic, population, and land/infrastructure-related engineering facts for a factual engineering analysis of the community's potential for stormwater utility creation as a potential problem solution. The basic facts explored include: population-specific data; land use and impervious surface data for the land mass; categorization data regarding ownership type and property usage; political process and approval system data; environmental needs assessment and project backlog data; water and sewage infrastructure and billing data; other user fee-based, tax, bond and project capitalization data and legislative histories; and citizen involvement group data. The information is collected in conjunction with community leaders and engineering/planning officials via an intensive interviewing and files searching process, and then analyzed using a ranking system (e.g., a matrix-driven ranking system) to determine important factors for launching a utility-based initiative in the community being studied. This rapid assessment study methodology, while more affordable at $30,000-50,000, is still sometimes too steep for governments to afford in off-budget times.

Funding sources covered under this present invention cover a wide range of interests and are documented following presentation of the second exemplary embodiment. It should be noted, however, that this listing of funding sources includes governmental sources, but as would be understood by one of ordinary skill and art, the funding typically does not come from the municipality for which the study and/or project is being performed. Thus, one municipality (e.g., one that already has a similar public works or environmental project complete) can fund another project for another municipality. Governmental investments include investments from Federal government sources (such as EPA, FEMA, Corps of Engineers, Department of the Interior, Bureau of Reclamation, and/or Department of Agriculture) and State environmental affairs or regulatory offices. Such Federal and State agencies may choose to participate in projects through grants or contract-driven assistance via a non-profit arm as well by providing grants as a source of an investment. Non-governmental investments are investments not from the Federal government sources or the State environmental affairs or regulatory offices. Hybrid investments are investments from a combination of the Federal and State agencies and from non-governmental sources. Investments may further be classified as for-profit and non-profit investments. Any combination of the above-investments types may be included as an “environmental-related project investment” herein as long as the projects are triggered by and are undertaken primarily because of an environmental concern or an environmental health and welfare-related concern. Excluded from the definition of an “environmental-related project investment” are (1) Privatizations or public/private partnerships to build infrastructure or buildings unrelated to an environmental issue and (2) a Government or a private entity using their own funds or creating their own means to make their own environmental improvements. Similarly excluded are toll roads, bridges, waste treatment plants that are designed, built, or increased in size due to simple demand, and where there is a will and means to finance it through conventional financing sources. If, however, there is an environmental impact, issue or concern attached to the bridge, road or plant that can be related to the project, then that portion that is environmentally-driven can be financed according to the invention. An example is an aqueduct that serves a purpose for a defined populace that would agree to a monthly service fee by gallons transported or some other method of user fee).

The above approach provides increased flexibility for the municipality or local government, allowing for separate financing vs. engineering vs. utility operations assistance contracts, if that is the requirement or desire of the local contracting entity in the community. Advances of various features of the present invention related to this exemplary stormwater management embodiment are described in the table below.

| | | Primary |
|---|---|---|
| | | Benefi- |
| FEATURE | BENEFIT | ciary |
| Reduces Study & | Decreases risk of EPA Penalty & | Local |
| Utility | reduces costs less for contract | Govern- |
| Start-up Time | administration. | ment |
| Privatization allows | Transfers $ risk to private entity for | Local |
| for study to launch | study phase work. | Govern- |
| without currently | | ment |
| budgeted funds. | | |
| Privatization allows | Transfers $ risk to private entity for | Local |
| Utility organization | Utility set-up phase work. | Govern- |
| design without | | ment |
| government funds. | | |
| Expert and other | Unique water resources firms and | Local |
| engineering | known & trusted engineers are not | Govern- |
| sources are used | competing, but brought together by | ment & |
| in this process. | the approach at fixed costs. | Engi- |
| | | neers |
| Process will highlight | Critical areas can be addressed with | Local |
| critical areas of | budgeted funds while program is | Govern- |
| stormwater program | built for longer-term care & | ment |
| and infrastructure | maintenance; “normal operations” | |
| needing attention. | are not diverted. | |
| Separate contracts | Maximum flexibility to meet legal | Local |
| can be designed for | and procurement regulations that | Govern- |
| study vs. utility | might exist at local levels. | ment |
| set-up vs. utility | | |
| operation. | | |
| Stakeholders briefed | Creation of user fee-based utility is | Local |
| early on & throughout | not a surprise AND not viewed as a | Govern- |
| process. | tax. | ment |
| User-fee based Utility | User fee income flow pays | Local |
| creation enables fair | privatization costs, study costs, | Govern- |
| cost distribution | utility operations costs AND creates | ment |
| to stakeholders. | fund for program and infrastructure | |
| | improvements. | |
| Use of leveraged | Allows local political leadership to | Local |
| private funds | display innovativeness and take | political |
| for government | credit for risk avoidance with EPA | leader- |
| programs. | and risk transfer for study costs. | ship |

One embodiment of the present invention uses its fund and affordable user fees over an extended term to provide a continuing, and enlarging, source of capital to fund project expansion and/or additional environmental projects. These funds can be combined with other available funding sources (including government grants) to support the total cost of completing an environmental solution project. Relative to diesel emissions, the invention can be used to provide funding for emission reduction retrofit equipment and the competent technical oversight needed for effective execution of projects designed to address diesel emission reductions within targeted industries like the trucking industry. In this case, the Concept Entity's Air organization manages the process and projects. This approach to funding environmental improvements:
Provides a very high degree of leveraging of government funds.
Creates the opportunity for government agencies at all levels to gain the use of privately-generated investment money as a source of capital for undertaking a wide range of environmental solution projects.
Eliminates the burdens of grant administration and reporting functions and, at the same time, achieves “turnkey” project implementation, if emission reduction product users choose to have government grant funds be handled through a nonprofit corporation, and
Provides project technical and administrative oversight, education, outreach, and technical support components, so that project participants and users of the environmental “solutions” provided by the project, are educated on the technology's functions and proper operation.

The current invention's process allows for a private investor-driven fund to be employed in programs and projects that are environmentally focused and that can be structured to allow for payback and returns-on-investment in the fund. This process involves revenue flow back to fund investors, along with options for re-charging the fund for purchase of additional equipment, to further EPA's diesel emission reduction goals. The methodology for payback of invested funds involves payment through user fees, establishment of a utility function, or other financial instrument, depending on the particulars of the product user and environmental issue involved.

To support the EPA SmartWay Program, the process of the present invention can be used to develop and implement a program that allows for upfront payments to acquire SmartWay Upgrade Kits for use by transportation vehicle owners, and creates a shared savings payback program (structured through a user fee arrangement) to achieve one or more of the following goals:
1) Enables truck owners to achieve both fuel savings and emissions reductions, and to gain technical support and knowledge about proper, environmentally conscious, and economically beneficial product selection and use;
2) Provides the inventor's organization with the ability to share fuel savings costs with trucking owners, and to create a return for fund investors;
3) Allows EPA to resolve the market impediment of needed upfront capital to achieve SmartWay Program success, and enable significant expansion in Program participants; and
4) Allows EPA to further leverage public funds through the use of a nonprofit entity for grants to assist particularly worthy projects and an operational mechanism that provides a percentage of funds for re-investment in more emissions reduction products.

Using some of the teachings of the present invention, cooperative partnerships between investors, management/technical companies and government can be formed to address pollution issues. For example, investors and management/technical companies can make funding and programs available to support vehicle operators involved in freight transportation by providing them with verified emission and fuel reducing products. Likewise, the government can provide and promote education and outreach on the existence of the available environmental-related project funding. Potential candidate fleets and vehicle operators can be screened to identify appropriate recipients of the environmental-related project funds and can receive educational and technical support needed to assure that those fleets select and use the best products for their application.

Upon identifying an appropriate fleet, specific funding and user fee agreements can be structured and/or negotiated with each party interested in receiving funding. Fleet services/products provider can then provide aggregation of funding to and receipt of user fees from owner-operator fleets interested in receiving funding. Emission credit and trading programs can then be established to quantify and qualify emission reduction credits from its funding customers, and will process the financial value of any such credits on behalf of its funding customers.

The missing link for the trucking industry to take advantage of the fuel usage and emissions reduction technologies is, quite simply, the availability of initial capital for the purchase, installation, training and use of the technology tools. The infrastructure already exists for easy installation of the technologies equipment by the major fleets who would gain the tools. Also currently, this industry already has the processes in place to track miles driven, engine running and employed, etc, so determining methodology for tracking operations of the trucks is easily assured. Therefore, employment of this invention resolves the only missing link in the resolution of an important environmental concern—reduction of diesel emissions in the trucking industry—while also providing a revenue stream from savings gained through lower diesel fuel usage. The capture of these revenue streams, a portion of which contains a user fee paid for use of the invention, is the subject of this exemplary embodiment for the trucking industry.

The process and method thus described for the trucking industry exemplary embodiment represents a general application of the model process for this invention that equally applies to applications in the rail, airports, ports, construction, service and transportation hauling, and bus/transit industries, among others that utilize fuel as an energy source (and diesel fuel in particular). The inventor's process allows for financing the placement of equipment and technologies that reduce diesel fuel usage and diesel emissions, resulting in earned fuel savings. These savings in the inventor's model are subject to a shared savings or user fee payment to the inventor, who then uses a portion of the shared savings to re-charge the fund, thus allowing for further fuel and emissions reductions on other vehicles in the user's fleet.

| | | Primary |
|---|---|---|
| | | Benefi- |
| FEATURE | BENEFIT | ciary |
| Reduces Study & | Gets cost-saving equipment in-place | Trucking |
| Equipment | faster | Companies |
| Installation | | &EPA |
| Start-up Time | | |
| Privatization | Reduces need for owners to find | Trucking |
| allows for study | investment capital for vehicle | Companies |
| to launch without | retrofits, & transfers $ risk to private | & EPA |
| currently budgeted | entity for the purchase | |
| funds. | | |
| Privatization | Transfers $ risk to private entity for | Trucking |
| allows User fee | User fee set-up phase work. | Companies |
| organization design | | |
| without | | |
| government funds. | | |
| Expert and other | Unique emissions reduction | Trucking |
| engineering | engineers and managers are used, | Companies, |
| sources are used | but brought together by the | EPA & |
| in this process. | approach at fixed costs. | Emissions |
| | | Reduction |
| | | Firms |
| Process will | Critical areas can be addressed with | EPA |
| highlight critical | budgeted funds while program is | |
| areas of diesel | built for longer-term care & | |
| fuel usage and | maintenance; “normal operations” | |
| emissions reductions | are not diverted. | |
| needing attention. | | |
| Separate contracts | Maximum flexibility to meet | Trucking |
| can be designed for | legal and procurement | Companies |
| EPA vs. trucking | regulations is assured | & EPA |
| company efforts | | |
| Stakeholders briefed | Creation of user fee is not a surprise | Trucking |
| early on & | AND is welcomed as a needed | Companies |
| throughout process. | innovation | & EPA |
| User fee enables | User fee income flow pays | Trucking |
| fair cost | privatization costs, study costs, | Companies |
| distribution to | operations costs, AND creates fund | & EPA |
| stakeholders. | for program enhancements and | |
| | more retrofits. | |
| Use of leveraged | Allows EPA leadership to display | Trucking |
| private funds | innovativeness and take credit for | Companies |
| for government | risk avoidance, with EPA | & EPA |
| programs. | participating by equipment funding | |
| | grants | |

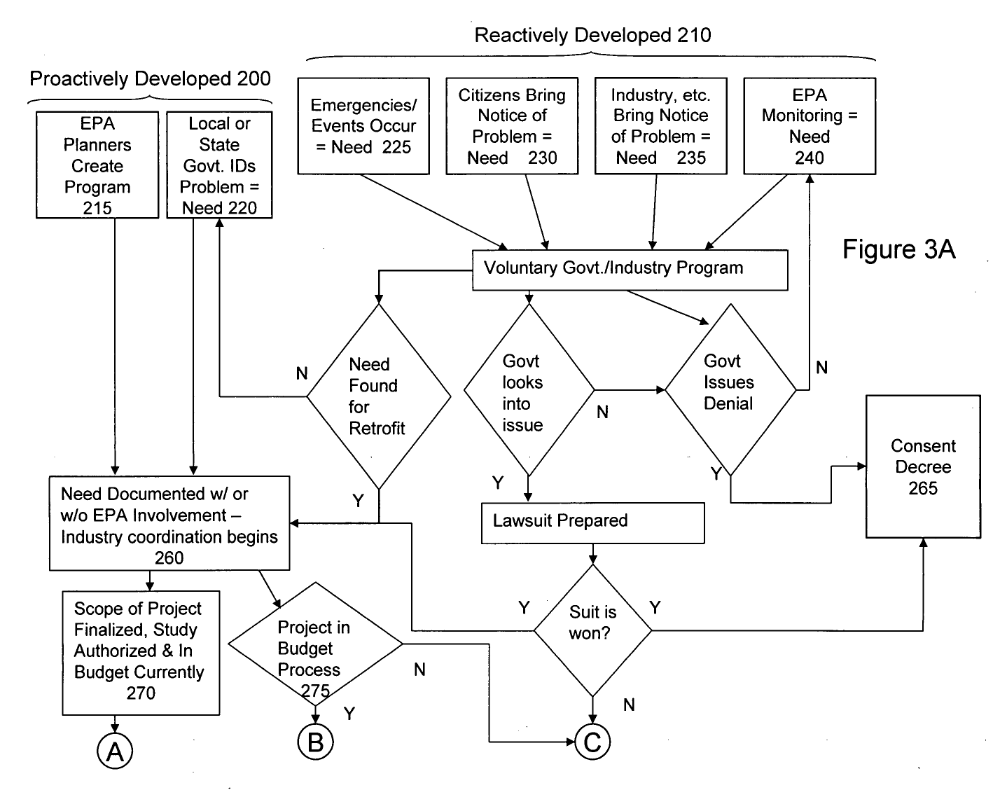

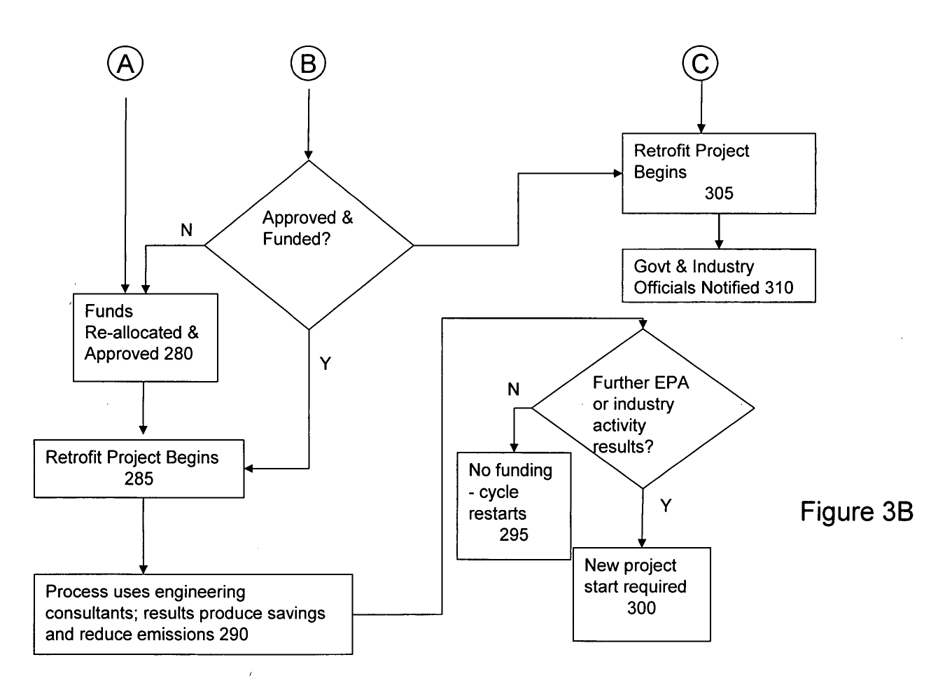

Turning now to FIG. 3, the flowchart presents a process of diesel fuel usage and emissions reductions projects and funding issues. The general process begins with actions that represent awareness of diesel fuel usage and emissions reductions issues. These actions are either proactively developed (200) or reactively developed (210). Proactive development involves a forward-thinking EPA planning office or department that either creates (215) programs for monitoring, encouraging, and supporting diesel fuel usage and emissions reductions programs or that employs active surveillance programs with State and local governments (220) to allow for early identification of problem areas and potential retrofit program opportunities. Such proactive-focused efforts document the program justification for a specific retrofitting initiative and the industry coordination step begins (in this case, with the trucking industry, though it could be the rail, airports, rental equipment, construction or other industries as well). These paths indicate the fastest path to successful establishment of a retrofitting initiative to reduce fuel usage and emissions.

On the other hand, reactive development (210) can be triggered through a wide variety of events:
Disasters or emergencies occur that bring immediate recognition to the diesel emissions problems in a local community (225);
Citizens living in fringe areas of major highways or inner city corridors where diesel traffic is greater, or active citizens'0 groups that uses and tracks community open space, bring notice to diesel emissions (230);
Industrial concerns wishing to develop certain large parcels of land raise issues concerning diesel emissions affecting their properties, or seek methods for starting diesel emissions initiatives affecting their own operations (235); and
EPA on its own, or through State conservation or other agencies, or through local concerned citizens' group involvement, gets involved in the issue through notifications of diesel emissions complaints (240).

Reactive development by its very nature entails a potentially combative process that both raises emotions over the diesel emissions issue and forces a greater bureaucratic response to creation of solutions. Unfortunately, as it affects this area, reactive development of programs is by far the more regular path of development. Regardless of the event that prompts a reactive development, some sort of voluntary government/industry program response generally (250) is required. Typically, unless the government departments involved have active emissions reductions or retrofitting program underway (which would be rare indeed), the government response is “to look into the issue” (255), which really results in a delay in the real response to the problem. In this case, local leadership will task a department or specialist (contracted or otherwise) to produce an analysis of the problem, and then a formal local government response is issued.

Whether a “look into the issue” is triggered or officials are at the ready with information, only two other outcomes are likely:

1) An emissions reduction or equipment retrofitting program need is identified (260); or

2) The local government and/or industry issues a denial of any problem (265).

A denial, of course, leaves open a path for State, EPA, or joint State/EPA examination of the difficulty, which could lead to preparation of a lawsuit. At this point, a successful suit prompts the same need for EPA involvement in program establishment (260) or possibly a “consent decree” which demands corrective action that also can mean establishment of a program (265). At this stage, either the study is: within the budget program currently in place (270); the study must be proposed for the next round of budget preparation (275); or the question of the need enters the government budget programming arena (280) where funds may be re-allocated as permitted to allow for urgent, mandated program needs. Any action beyond that involving funding currently available in established budgets indicate time delays (sometimes very significant) into the process.

After budget process and time delay-related problems are tackled, the actual process of beginning diesel emissions retrofitting project is initiated (285). Most local governments and EPA offices for that matter in the US lack the internal engineering expertise to undertake these projects on their own resources. As a result, services (290) are procured through outside-contracted activities, typically involving an engineering consultant selected through some existing contractual arrangement or through some procurement process.

While engineering costs for this type of work certainly are affected by regional cost fluctuations, it is fair to say that the there is also cost variation due to the size of a fleet of vehicles or other diesel equipment included in the program. Generally, cost of a single retrofit varies between $3,000 - 12,000 for trucks, and upwards of $45,000 for rail/locomotive equipment, as just an example. A logical national average cost of retrofit projects, therefore, is in the hundreds of thousands of dollars. In most cases, the project cost alone is enough to scare off even positive-minded public servants and profit-minded corporate owners of fleets. Complicating this issue is the fact that conduct and scope vary greatly area to area, resulting in a wide degree of differences in complexity of results.

Unfortunately, this wide dispersion of complications and results also sometimes sidelines the creation of retrofit projects designed to correct problems. Recognizing the market potential that exists as a result of these circumstances, very specialized firms having expertise in the engineering and program aspects of diesel retrofitting have formed and have expressed interest in working with EPA and the industry on solutions. A few have created specialized service offerings. Use of such a firm greatly simplifies the work for a local government, and potentially offers cost savings in the event projects are considered feasible. Nonetheless, the end result of far too many good demonstration programs is that the limited advances and improvements end with the final retrofits that were bought in the project in question, without any prospect for continued activity (295).

The general process for local government and industry approval and development of a diesel retrofitting program (FIG. 3) then ends, with the only prospect for continued diesel emissions reduction initiatives being a new project start (and thus the repeat of this entire process) (300).

Of course, if the lawsuit is lost, or if EPA fails to gain grant or project approval, or if programmed projects simply do not gain budgetary funding, the retrofitting opportunity simply dies (305), and government/industry officials who may have worked exceedingly hard to cooperate on diesel fuel and emissions reductions are left in frustration and at status quo.

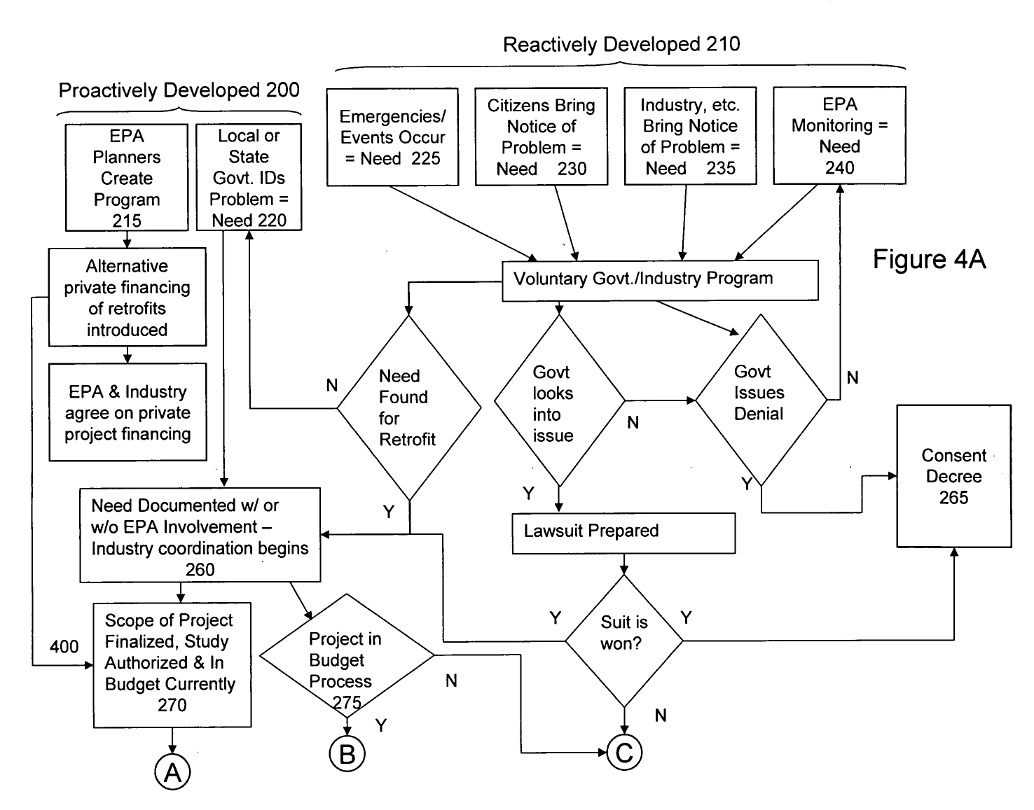

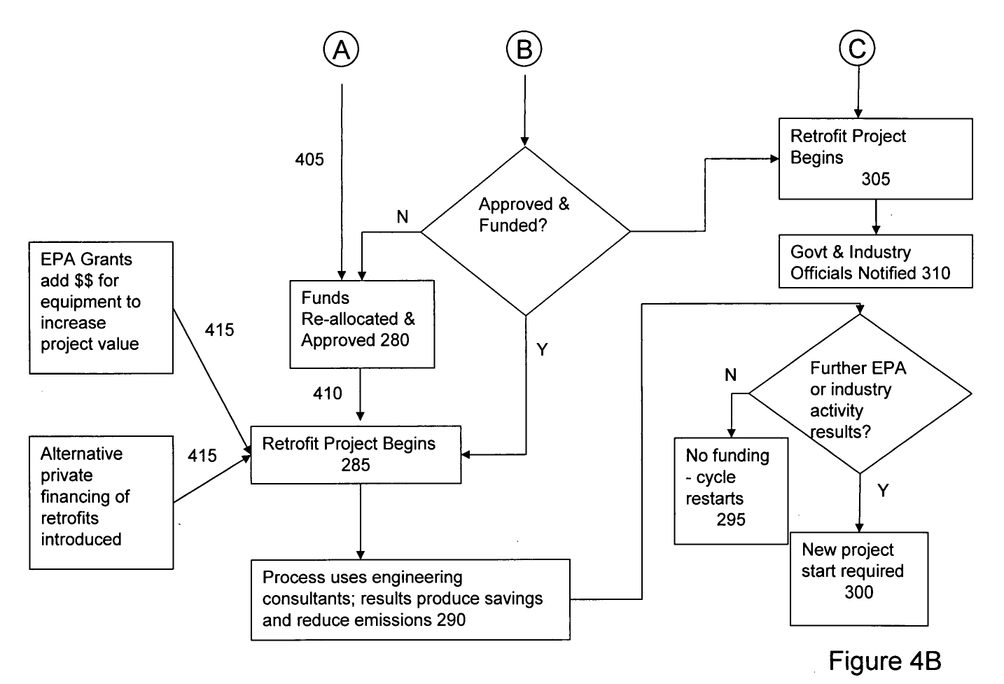

Turning now to FIG. 4, the method of the present invention reduces risks of project failure by providing an entirely new method of both “priming the pump” for new retrofit initiatives, and allowing EPA an opportunity to leverage its public grant funds for such projects. Additionally, it is possible to privately fund any one or a combination of costs through a mixture of private sources together with both the inventor's Concept Entity (for air solutions) and EPA without departing from the spirit of the present invention. Moreover, it is possible to fund a portion or percentage of any one or a combination of costs without departing from the spirit of the present invention such that the private investor, the industry and EPA or the state/local government sponsor share in the risk/reward of the project.

The present invention utilizes alternative project financing in order to fund various stages of a wide variety of emissions reduction, diesel fuel usage reduction, or a combination of diesel fuel usage and emissions reduction, such as is the case with EPA's SmartWay Retrofit Kits. Doing so may require tactical meetings, briefings, and privatization concept introductions to key EPA, State and local government, and fleet ownership and leadership in the communities involved. The approach may also involve tactical outreach meetings with known and respected “legacy” engineering and/or corporate contacts at the local level that understand the issues, geography, and project development-related impacts of their local community.

To implement the project, a variety of team members and experts may be utilized, including but not limited to investor representatives, fund leadership/officers, experts in diesel fuel usage reduction technologies, diesel emissions technologies, and technical staff of contracted engineering support specific to detailed engineering and/or retrofitting management tasks. A private funding option proposal is then prepared and presented to the leadership for consideration in resolving the community's stormwater management difficulties.

According to the present invention, and again turning back to FIG. 4, project financing for the retrofitting initiative provided by the Concept Entity's Air organization significantly shortcuts the general project flow process described in FIG. 3. These shortcuts are depicted on FIG. 4 by elements 400, 405 and 410 and show dramatic changes to the typical funding process employed for retrofitting initiatives. The typical EPA and/or state government project process is reduced at the program-to budget approval stage (400), at the project scoping through budgeting phase (405), and through the allocation and project start phase (410). All become unnecessary with the infusion of privately financed capital funds, which saves the industry involved from seeking capital expenditure of operations funds they do not have and cannot easily get through other means for emissions reductions programs.

At the same time, the private funding process envisioned by the Concept Entity for Air allows for direct governmental involvement either through indirect participation and public affairs-related advancements of the progress made or directly through link-ups to grant programs or direct grants to the Air organization (enabled through the non-profit funding arm of the Concept Entity) (415).

Funding sources covered under this present invention cover a wide range of interests and are documented following presentation of the second exemplary embodiment. It should be noted, however, that this Listing of funding sources includes governmental sources, but as would be understood by one of ordinary skill and art, the funding typically does not come from the municipality for which the study and/or project is being performed. Thus, one municipality (e.g., one that already has a similar public works or environmental project complete) can fund another project for another municipality.

Employment of nonprofit contributions or government-sponsored grant monies as contributing dollars for success of the program for the trucking industry, are important elements of the exemplary embodiment for the trucking industry. Because the trucking industry has taken an active interest in increasing efficiency, decreasing diesel fuel usage, and decreasing diesel emissions, the inventor has included a methodology allowing for contribution of both grant monies and nonprofit/not-for-profit contributions to be made in its fund, administered through and managed by a separate, nonprofit corporation arm of the inventor's Concept Entity.

The above approach provides increased flexibility for the municipality or local government, EPA, and the industries involved, allowing for separate financing vs. engineering vs. equipment contracts, if that is the requirement or desire of the project's interested parties.

The financing provided for the retrofitting project enables the purchase and installation of various retrofitting equipment that: (1) Automatically shuts on/off a diesel engine in order to maintain a constant block temperature necessary for maximum fuel efficiency when it is idling; (2) Creates minimum air disturbance and therefore maximum fuel efficiency for the vehicle involved; (3) Minimizes emissions from the diesel engine through a number of different filters, catalytic converter-type systems, or other emissions reductions technologies that are outfitted to a diesel engine; and/or fuel usage and emissions tracking devices that are added to the engine for tracking and controls purposes.

The Concept Entity for Air is repaid its capital cost for the various equipments through a negotiated contract for user fees with the government and/or industry owner and operator of the diesel equipment over the life of the equipment. When the equipment involves diesel fuel usage reduction technologies (such as in the EPA SmartWay program), such user fees are generated as a percentage of the actual fuel usage reduction gained through use of the technologies. In this later case, the owner/operator of the diesel equipment actually decreases its operating costs and adds to its bottom line thorough the SmartWay program, making this inventor's process especially enticing to the industry owners.

Additional Examples of Invention Application in Land, Industries, and Infrastructure Applications

Environmental difficulties and loss of land resources, especially in US coastal communities, is a recurring problem affecting coastal populations and their governance. The problems typically involve depletion of shoreline or coastal shore sand resources, coastal barrier and shoreline protection, and other effects of shoreline erosion. Traditional methods of redress (beach nourishment projects, placement of breakers and ocean groins, and/or refurbishment of dune structures) usually reach critical stages in coastal communities before public funding is allocated or found to deal with the problem. Generally, the US Army Corps of Engineers becomes involved at the request of petitioning governances to find methods of protecting and paying for land (beach) protection and re-nourishment initiatives. Such projects, however, are constantly challenged by lack of consistent governmental funding, making such projects ideal candidates for application of this invention's process. The Concept Entity's land organization may structure the particular public works and environment project in this area for completion, with the understanding from the local governance that user fees will be designated from “per bed” assessments in tourist communities, from beach accessory rentals, from parking lot fees, or from a portion thereof of any such existing or designed fee-based initiatives. As with the detailed exemplary embodiments for stormwater and diesel fuel, the Concept Entity's fund would be employed to finance the improvements, and the Concept Entity and its fund investors would be re-paid and earn a portion or percentage of collected fees for employment of the concept to resolve the community's environmental and public works challenge.

Environmental problems peculiar to a particular industry type are often very difficult to tackle for the industry itself or the area governmental authority established within the operations of the industry. Typically, the industry employs a substantial portion of the local populace, who of course are reticent to be vocal about environmental concerns if such concerns might threaten employment operations of the industry. In turn, the government overseer at the local level likewise gains tax revenue by the placement and operation of the industry within its geographic boundaries, so the symbiotic relationship tends to influence local enforcement of or cleanup of environmental problems, unless the problems become severe. Regardless of severity, though, these industrial-related environmental problems and their clean-ups result in tremendous financial hardship for the local government and industry alike, and financial sources to apply to resolution of the problems are scant or nonexistent. The Concept Entity's industries organization may structure the particular public works and environment project in this area for resolution of specific environmental problems, with the understanding from the local governance and/or the industry will establish set user fees for the market area served by the industry. An example is the timber industry, which has often been plagued by environmental concerns not only for diesel and engine emissions but as well for toxic silt buildup in local streams and water bodies due to sawdust wash-off from operations. As with the detailed exemplary embodiments for stormwater and diesel fuel, the Concept Entity's fund would be employed to finance emissions-related and silt removal/water treatment-related improvements, and the Concept Entity and its fund investors would be re-paid and earn a portion or percentage of collected fees for employment of the concept to resolve the community's environmental and public works challenge.

There are tens of thousands of poorly maintained, at-breech risk, earthen dams located throughout the US that are employed for water supply, agricultural, and recreation purposes. Because these dams serve a public purpose, they are considered infrastructure, though in the vast majority of cases, the local government entity overseeing safety of the structures is ill-funded to either inspect, repair, or maintain the dams' integrity. Closing the dams is not an option in most cases, simply because the dams are important to the vitality of the local economy. These engineering inspection, repair, and restoration of the dams result in tremendous financial hardship for the local government, and financial sources to apply to resolution of the problems are scant or nonexistent. The inventor's Concept Entity (and its infrastructure organization in particular) may structure the particular public works and environment project for resolution of these specific environmental problems, with the understanding from the local governance that a user fee for the market area will be established. In this particular case, constituents of a water supply dam may have an increase in water bills to cover the user fee; constituents using the lake created by the dam for recreation purposes may be charged a recreational user fee for the improvements; and the constituents of an agricultural dam may be charged a fee for planted acreage as a user fee. The Concept Entity and its fund investors would be re-paid and earn a portion or percentage of collected fees for employment of the concept to resolve the community's environmental and public works challenge.

Another exemplary environmentally-driven project includes, but is not limited to: Improvements in a waste treatment plant where a new technology allows for the enhancement of design or process that was beyond the project's original scope, but that brings a higher environmental value to the entire process. An example is a new filtering process or technology that allows for greater capacity usage and derives a cleaner product, and that a served populace or industry wants it and agrees to a user fee to pay for the improved level of service that is beyond the mandated level of performance.

This invention is intended to create the opportunity for advancement of environmental initiatives and projects for both private and public sector clients that recognize but cannot afford to undertake projects without some form of innovative financing. The process outlined and financing provided in the invention therefore offer win-win opportunities for planning, Architecture/Engineering/Construction, and engineering design firms that provide project services in the environmental-related markets. The invention offers needed financial resources to such firms and their clients (municipalities and private sector entities) who have identified project needs and who can accept a funding process methodology either as a separate contract or as part of an overall financing and technical execution-level contract involving both the engineering firm and the concept entity. In this way, each entity provides its specialized expertise (i.e., the engineering firm providing its technical know-how in the local community and its specific client understanding, and the concept entity providing its process and project financing as outlined in the invention). Further, the concept entity in this way provides opportunities for the engineering firm and its clients to fund multiple projects, to fund follow-on endeavors, or to assist another “partner” municipality on a similar venture through linkage with the concept entity.

The inventor also foresees the opportunity for use of the process and financing methodology noted herein employed in the replacement of fossil fuel technologies used as energy sources in industry with environmentally cleaner technologies involving solar, wind, nuclear, or other energy sources. Such replacements (available now or to be made available in the future) are expensive undertakings and require capital financing that is usually beyond the reach of industries currently relying on traditional, fossil-based fuels. The use of the concept entity's process is therefore warranted because the replacement is an environmentally conscious and driven endeavor that can be afforded through the use of a user fee (such fee taking the form of an add-on amount or percentage of money to the end product produced). It should be noted, though, that the inventor does NOT intend for an engineering company to be limited in the self-funding of a singular project of their own for a one-time project return in service to a client. This invention, instead, is offered to spur additional environmental initiatives and worthy projects that benefit both the client and the performing engineering firm.

The above methods can utilize investor outreach and involvement from a wide range of potential sources (both domestic and foreign), including, but not limited to (headings are illustrative and not definitional):

A. Individuals
Loans (secured, unsecured, and/or personally guaranteed)
Equity investments (directly or via a business entity)
Donations and grants (while living or bequeathed)(direct or indirect)( tax-deductible or not)

B. Business entities
Trusts (loans, grants, program-related investments), including Corporate, Individual, Charitable, Revocable and Irrevocable Trusts Estates
Federal, state, and municipal government grant and loan programs Corporations (“C”, “S”, and government-chartered)
Limited Liability Companies (LLCs)
Limited Liability Partnerships (LLPS)
Professional Corporations (PCs)
Limited Partnerships (LPs)
Partnerships
Small Business Investment Corporations (SBIC)

C. Governmental entities (Municipal, State, Territorial, Federal and International)
Public/Private Partnerships
Agencies, departments, bureaus, or authorities
Special tax, assessment, fee, and/or collection districts
Government grants
Government contracts to furnish goods, materials and/or services
Government loan programs (including small, minority, and disadvantaged business)
Native American governments, bureaus, agencies and authorities

D. Miscellaneous Funding Sources
“Angel investors”
Venture capitalists, corporate venture capital and Venture capital funds
Manufacturers, distributors, suppliers, installers, and operators of equipment and supplies used in the water, wastewater, and construction industries
Builders and/or developers (commercial and/or residential)
Investment Clubs
Public, private and municipal utilities
Single-purpose entities
Bootstrap Financing
Owner financing
Mezzanine financing
Bridge financing
Institutional financing
Private capital investors
Private investor funds (whether an individual, group, association, institutional or business entity investor)
User fees
Impact fees
Dedicated tax revenues

E. Nongovernmental Charitable and Not-For-Profit entities
Public charities
Foundations (private and public)
Donor-advised funds
Private operating foundations
Unions (including loans, grants, and pension funds)
Fraternal and civic organizations
Industry and other associations
Charitable trusts

F. Financial Institutions
REITs (real estate investment trusts)
REMICs (Real Estate Mortgage Investment Conduits)
Hedge funds
“Alternate investment” vehicles
Insurance companies:
   Insurance reserves
   Pension funds
   Hedge funds
Retirement/pension funds:
   Simplified Employee Pension plans (SEPs)
   Individual Retirement Accounts (IRAs)(traditional and/or Roth)
   Keogh plans
   Defined benefit plans
   Profit sharing plans
   401 (k) or 403(b) plans
   Qualified or unqualified
   Corporate, small business, governmental, not-for-profits and individual
Banks, Savings and Loans, Credit Unions and Brokerages:
   Line of credit
   Commercial business loan
   Mortgage loan
   Margin loan
Brokerages:
   Private placements
   Loans (all types)
   Commercial paper
   Brokerage-sponsored mutual funds
   Private investment funds

G. Financial Instruments
Asset-backed securities
Equity or partnership capital
Certificates of deposit
Initial public offering
Exchange-traded funds
Mutual funds
Preferred stock
Participation notes and/or certificates
Commercial paper
Sale of bonds or notes (whether private and/or public, general obligation, corporate, municipal,
   asset-backed, mortgage, revenue, senior, subordinated, participating, nonparticipating,
   high-yield, sinking fund, or other debt instruments)
Private equity or debt investments (private placement, direct, brokered, or provided/underwritten/purchased by an owner, operator or vendor of a subject project

Thus, according to the invention, environmental-related project investments can be utilized to pay for projects, or to pay for various stages of environmentally-driven public or private works. In return, the investors can be paid out of repayment fees including at least one of a portion of the utility or other user fees that are collected as a result of the inventor's process. The repayment fees received by the investors can be any one or a combination of various payout models derived from project improvements including but not limited to: a portion or percentage of utility fees or revenues; a fixed or percentage-basis user fee; a cost plus a fixed dollar amount; cost plus a percentage of utility fees; a fixed dollar amount over a certain period; a percentage of fees over a certain period; a percentage of the amount of any specified, levied fee or penalty that is avoided; a percentage of shared savings; a small add-on fee to the price of a factory-produced or industry-manufactured product or offered consumer service that is added at the original equipment manufacturer or servicer level; the value or a percentage of value from credits that might be produced, traded, or sold within an industry, to the public, or to select shareholders, etc. Moreover, such fees that will be managed by the inventor's Concept Entity can be structured as an annuity, such that the upfront costs are treated as funds-in-revolving use, and paid back on a set level of return over a set period of time in either variable or fixed percentages, based on success of the projects. The inventor understands that such fees may also be built into program or project management approaches, joint venture arrangements, roll-ups of project or infrastructure programs, regionalization initiatives, private bonding ventures, or may result in massing of fee revenues for Initial Public Offerings (IPOs) or other commercialization concepts, all of which form the basis of and are included within this application. It should be noted, however, that the inventor does not foresee or include earned fees that are in any way tied to a community's conventional and typical taxation or public bonding processes used by their governmental authorities. Rather, the invention is designed to resolve environmental problems that have a distinct and definable audience and not simply the “general public,” even though the “general public” benefits overall by creating a cleaner environment through the execution of the concept entity's projects.

As would be appreciated by those of ordinary skill in the art, debts in the form of annuities (as well as other contractual debts) may also be sold to other potential investors later. For example, after a project has been started and a client is obligated to pay back $1 million dollars times a 1.8 multiplier, the inventor's Concept Entity and its initial investors may sell the annuity to a third party that wishes to take over the annuity and risk. Moreover, certain groupings of annuities or portions of annuities may be sold to third party investors. Similarly, the inventor's Concept Entity and its first set of investors may exchange an interest in the first annuity for an interest in a second annuity held by another set of investors to reduce the risk of the first and second set of investors in any one investment.

According to the present invention, repaying investors using a portion of the fees collected can be either direct repayment (e.g., monthly, quarterly or annual fees as the fees are collected by using a portion of the collected fees) or indirectly (e.g., by the municipal government or private client pay back the inventor's Concept Entity and its investors through a loan, bond, or other timed financial vehicle).

The present invention further includes a computer system and a computer-implemented method for tracking the costs and payments due according to the public works or environmental projects financed by the nongovernmental funding source.

Numerous other uses for the present invention and variations thereof will become apparent to those of ordinary skill in the art in light of the above disclosure. Accordingly, the present invention is not intended to be limited by the above disclosure, and only the appended claims define the scope of protection sought by applicants.

1. A method of financing an environmentally-driven public or private works project, comprising:
(a) funding costs associated with an environmentally-driven public or private works project with a revolving environmental-related project investment;
(b) collecting repayment fees including at least one of a portion of user fees and a portion of utility fees from users of the environmentally-driven public or private works project; and
(c) repaying the revolving environmental-related project investment with at least a portion of the repayment fees collected from the users of the environmentally-driven public or private works project.

2. The method claimed as claimed in claim 1, wherein the revolving environmental-related project investment comprises a non-governmental investment.

3. The method claimed as claimed in claim 1, wherein the revolving environmental-related project investment comprises a governmental investment.

4. The method claimed as claimed in claim 1, wherein the revolving environmental-related project investment comprises a hybrid investment including both a governmental investment and a non-governmental investment.

5. The method claimed as claimed in claim 1, wherein the costs associated with the environmentally-driven public or private works project comprise costs of a stormwater management study.

6. The method claimed as claimed in claim 1, wherein the costs associated with the environmentally-driven public or private works project comprise costs of a diesel fuel usage and emissions reduction study.

7. The method as claimed in claim 1, wherein the costs associated with the environmentally-driven public or private works project comprises costs of at least one of building and purchasing stormwater management resources.

8. The method as claimed in claim 1, wherein the costs associated with the environmentally-driven public or private works project comprises costs of at least one of building and purchasing diesel fuel retrofitting resources.

9. The method as claimed in claim 1, wherein the costs associated with the environmentally-driven public or private works project comprise costs of maintaining stormwater management resources.

10. The method as claimed in claim 1, wherein the costs associated with the environmentally-driven public or private works project comprise costs of maintaining diesel fuel retrofitting resources.

11. The method as claimed in claim 1, wherein the costs associated with the environmentally-driven public or private works project comprises costs of running the project for an initial, specified period of time.

12. The method as claimed in claim 1, wherein repaying comprises repaying the revolving environmental-related project investment plus a percentage of collected user fees or utility fees.

13. The method as claimed in claim 1, wherein repaying comprises repaying the non-government investment plus a fixed amount.

14. The method as claimed in claim 1, wherein the revolving environmental-related project investment is an investment not from either the EPA or the government of the community in which the environmentally-driven public or private works project is to be built or maintained.

15. The method as claimed in claim 1, wherein the revolving environmental-related project investment is a revolving environmental-related project investment for multiple media.

16. A method of administering an environmentally-driven public or private works project, comprising:
(a) collecting repayment fees including at least one of a portion of user fees and a portion of utility fees from users of the environmentally-driven public or private works project; and
(b) repaying a revolving environmental-related project investment that was used to fund at least a portion of the environmentally-driven public or private works project with at least a portion of the repayment fees.

17. The method claimed as claimed in claim 16, wherein the revolving environmental-related project investment comprises a non-governmental investment.

18. The method claimed as claimed in claim 16, wherein the revolving environmental-related project investment comprises a governmental investment.

19. The method claimed as claimed in claim 16, wherein the revolving environmental-related project investment comprises a hybrid investment including both a governmental investment and a non-governmental investment.

20. The method claimed as claimed in claim 16, wherein the revolving environmental-related project investment that was used to fund at least a portion of the environmentally-driven public or private works project comprises costs of a stormwater management study.

21. The method claimed as claimed in claim 16, wherein the revolving environmental-related project investment that was used to fund at least a portion of the environmentally-driven public or private works project comprises costs of a diesel fuel usage and emissions reduction study.

22. The method as claimed in claim 16, wherein the environmental-related project investment that was used to fund at least a portion of the environmentally-driven public or private works project comprises costs of at least one of building or purchasing stormwater management resources.

23. The method as claimed in claim 16, wherein the revolving environmental-related project investment that was used to fund at least a portion of the environmentally-driven public or private works project comprises costs of at least one of building or purchasing diesel fuel retrofitting resources.

24. The method as claimed in claim 16, wherein the revolving environmental-related project investment that was used to fund at least a portion of the environmentally-driven public or private works project comprises costs of maintaining stormwater management resources.

25. The method as claimed in claim 16, wherein the revolving environmental-related project investment that was used to fund at least a portion of the environmentally-driven public or private works project comprises costs of maintaining diesel fuel retrofitting resources.

26. The method as claimed in claim 16, wherein the revolving environmental-related project investment that was used to fund at least a portion of the environmentally-driven public or private works project comprises costs of running the project for an initial, specified period of time.

27. The method as claimed in claim 16, wherein repaying comprises repaying the revolving environmental-related project investment plus a percentage of collected user fees or utility fees.

28. The method as claimed in claim 16, wherein repaying comprises repaying the non-government investment plus a fixed amount.

29. The method as claimed in claim 16, wherein the revolving environmental-related project investment is an investment not from either the EPA or the government of the community in which the environmentally-driven public or private works project is to be built or maintained.

30. The method as claimed in claim 16, wherein the revolving environmental-related project investment is a revolving environmental-related project investment for multiple media.

31. A computer-implemented method of financing an environmentally-driven public or private works project, comprising:
(a) determining costs associated with an environmentally-driven public or private works project that were funded with a revolving environmental-related project investment;
(b) tracking repayment fees including at least one of a portion of user fees and a portion of utility fees from users of the environmentally-driven public or private works project; and
(c) repaying the revolving environmental-related project investment with at least a portion of the repayment fees collected from the users of the environmentally-driven public or private works project.

32. A computer-implemented method of administering an environmentally-driven public or private works project, comprising:
(a) tracking repayment fees including at least one of a portion of user fees and a portion of utility fees from users of the environmentally-driven public or private works project; and
(b) repaying a revolving environmental-related project investment that was used to fund at least a portion of the environmentally-driven public or private works project with at least a portion of the repayment fees.

33. A computer program product for controlling financing of an environmentally-driven public or private works project, comprising:
a computer readable medium; and
instructions embedded within the computer readable medium for controlling a computer to perform the steps of:
(a) determining costs associated with an environmentally-driven public or private works project that were funded with a revolving environmental-related project investment;
(b) tracking repayment fees including at least one of a portion of user fees and a portion of utility fees from users of the environmentally-driven public or private works project; and
(c) repaying the revolving environmental-related project investment with at least a portion of the repayment fees collected from the users of the environmentally-driven public or private works project.

34. A computer program product for administering an environmentally-driven public or private works project, comprising:
a computer readable medium; and
instructions embedded within the computer readable medium for controlling a computer to perform the steps of:
(a) tracking repayment fees including at least one of a portion of user fees and a portion of utility fees from users of the environmentally-driven public or private works project; and
(b) repaying a revolving environmental-related project investment that was used to fund at least a portion of the environmentally-driven public or private works project with at least a portion of the repayment fees.
